(19) United States
(12) Patent Application Publication
(10) Pub. No.: US 2006/0093788 A1
(43) Pub. Date: May 4, 2006

(54) Disposable food preparation mats, cutting sheets, placemats, and the like

(75) Inventors: Richard J. Behm, Appleton, WI (US); Heather Anne Sorebo, Appleton, WI (US); Elizabeth Anne Hines, Appleton, WI (US); Thomas G. Shannon, Neenah, WI (US); Jeffrey J. Johnson, Neenah, WI (US); Henry Skoog, Marietta, GA (US); Fung-jou Chen, Appleton, WI (US); Jeffrey Dean Lindsay, Appleton, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 10/977,486

(22) Filed: Oct. 29, 2004

(51) Int. Cl. B32B 3/10

(52) U.S. Cl. 428/137

(57) ABSTRACT

Disposable liquid absorbent mats are described. The mats generally include at least a liquid absorbent layer and a liquid impervious layer. The liquid absorbent layer may be made from a tissue web, a hydroentangled web, an airlaid web, a coform web, and the like. The liquid impervious layer, on the other hand, may comprise a meltspun web, a film, a hydroentangled web, or even a tissue web that has been treated with a sizing agent that renders the web resistant to fluid flow. In one embodiment, the mats can be made so as to have a relatively low caliper so that the mats can be spirally wound into a roll. In other embodiments, however, the mats may be packaged in a stacked arrangement. The mats have various uses and applications. For instance, the mats are well suited for use during food preparation. The mats are well suited to absorbing fluids while preventing the fluids from striking through the product. In some embodiments, the mats are also well suited to serve as an absorbent and cut resistant surface. An added benefit is the addition of a layer of polymer to the bottom side of the film to achieve non-slip feature to an absorbent and cut resistant food prep mat.

### BACKGROUND OF THE INVENTION

During the preparation of meals or of a particular dish, foods are typically defrosted, cut, chopped, sliced, or otherwise manipulated. These operations typically occur on a countertop or other hard surface. During food preparation, cleanliness is important not only for maintaining a clean workspace but also to prevent against cross contamination of the food items.

In the past, many of the above described food preparation steps have occurred on a cutting board, over a paper towel, or directly on a countertop surface. The cutting boards or countertop surface, however, must be cleaned after each use. Paper towels may be useful in absorbing excess liquid or juices. Paper towels, however, allow the liquids or juices to strike through the product and contaminate any surface on which the paper towel is placed.

In view of the above, a need currently exists for a disposable product that can be used to prepare meat and other raw or cooked foods. In particular, a need exists for a disposable food preparation mat or sheet that is capable of absorbing liquids from the food, while preventing penetration of the liquids to the surface on which the mat rests. There is also a need for some food preparation that the mat is absorbent and has a degree of cut resistance.

There is also a need for a disposable food preparation mat that may be produced in a rolled form, similar to a roll of paper towels. For example, a need exists for a food preparation mat that is flexible and non-ridged such that multiple sheets may be spirally wound into a product so as to minimize the amount of storage area required for the product and increase the ease of disposal.

### SUMMARY OF THE INVENTION

In general, the present invention is directed to fluid absorbent mats. The mats can be used in numerous applications. For example, in one embodiment, the mats can be used during food preparation in order to absorb and retain excess liquid or juices that may arise, for instance, when food is defrosted, cut, chopped, sliced, or otherwise manipulated. When cutting, chopping or slicing is required during food preparation, cut resistance is also required in addition to absorbency. In addition to food preparation applications, the mats are also well suited for chemical spill absorption, blood, urine or other body fluid absorption or any other similar application. The mats may also be decorated with graphics to improve their aesthetic appearance. In this manner, the mats are also well suited for use as placemats at a dinner table.

For many applications, the fluid absorbent mats of the present invention are intended to be disposable and thus discarded after a single or multiple uses. In one particular embodiment, the fluid absorbent mats of the present invention are contained on a spirally wound roll. The roll may contain a plurality of mats that are separated, for instance, by a perforation line that allows a user to remove one mat from the roll at a time. In other embodiments, however, the fluid absorbent mats may be packaged in a flat stacked arrangement.

In one particular embodiment, the present disclosure is directed to a rolled absorbent product comprising a plurality of spirally wound interconnected fluid absorbent sheets. While not overly critical to the invention, the size of the concentrically wound roll may approximate the dimensions of a standard roll of paper toweling, having an outer roll length (sheet width) dimension of from about 8″ to about 14″ and a roll diameter of from about 3″ to about 9″. The length of the sheet on the roll is determined by the particular diameter of the roll and the caliper of the sheet. In this manner the consumer may find the product advantageous to use as a regular paper towel as well as other purposes such as a food preparation mat.

The sheets include a first hydrophilic and fluid absorbent layer and a second fluid impervious layer. The first layer of the sheets may have a HST (Hercules Size Test) value, for instance, of less than about 5 seconds, while the second layer of the sheets may have a HST value of greater than about 1 minute, such as greater than about 4 minutes. The composite sheet, has an HST value of greater than about 1 minute. When contained in a spirally wound arrangement, the fluid absorbent sheets may have a relatively small caliper, such as less than about 1,000 microns. For example, in one embodiment, the caliper of the sheets may range from about 40 microns to about 800 microns. The basis weight of the sheets, on the other hand, may be less than about 400 gsm, such as from about 5 gsm to about 100 gsm, such as from about 10 gsm to about 80 gsm.

The fluid absorbent layer and the fluid impervious layer contained within the absorbent sheets may vary depending upon the particular application and the desired result. Further, the sheets may be constructed from a single ply in which the layers are stratified over the thickness of the ply. In other embodiments, however, the absorbent sheets may comprise laminates in which the fluid absorbent layer comprises a first ply that is adhered or connected to the fluid impervious layer which may comprise a second ply.

As described above, in one embodiment, the fluid absorbent layer may comprise a tissue web. The wet laid tissue web can be formed by any of a variety of papermaking processes known in the art. For example, the tissue web may be formed utilizing adhesive creping, wet creping, double creping, double re-creping, embossing, wet-pressing, air-pressing, through-air drying, creped through-air drying, uncreped through-air drying, as well as other steps known in the art. In addition to the above, the fluid absorbent layer may also comprise an airlaid web made from, for instance, fluff pulp and/or other cellulosic fibers such as cotton or rayon fibers. The fluid absorbent layer may also comprise a coform web or a hydroentangled web. For many applications, the fluid absorbent layer should have a specific absorbent capacity of greater than about 1 gram water to gram mass, such as greater than about 2 grams water per gram mass. In one embodiment, for instance, the absorbent capacity of the fluid absorbent layer may be greater than about 4 grams water per gram mass.

The fluid impervious layer may comprise a nonwoven or a film. The film may be made from any suitable polymeric material, such as polyethylene, polypropylene, nylon, TEFLON, PEEK, polyphenylene sulfide and the like. Hydrophobic nonwoven webs that may be used as the fluid impervious layer comprise meltspun webs, such as meltblown webs, spunbond webs, hydroentangled webs, and the like. If desired, the meltspun nonwoven web may be hot calendered in order to further decrease the liquid permeable properties of the material.

Particular examples of fluid absorbent sheets made in accordance with the present invention include a film laminated to an uncreped through-air dried highly textured web. Uncreped through air dried tissues such as that described in U.S. Pat. Nos. 5,672,248; 5,656,132; 6,120,642; 6,096,169; 6,197,154; 6,143,135 which are all incorporated herein by reference, are found to have better bulk, greater wet resiliency and higher specific absorbent capacity than traditional wet pressed tissue products. Thus, less cellulose fiber is needed to maintain specific absorbent capacity. In addition, the ability to impart a 3 dimensional pattern into the tissue provides the opportunity to increase the specific absorbent capacity of the sheet when laminated to a fluid impervious layer. The excellent wet resiliency of the sheet allows the sheet to retain its 3-D form rather than collapsing into the voids between the film and the fiber surfaces.

In another embodiment, the fluid absorbent sheet may comprise an airlaid web laminated to a film such as a polyolefin. In still another embodiment, the sheet may comprise a hydroentangled web laminated to any suitable film. In still another embodiment the sheet may comprise a highly debonded sheet comprising a latex binder. The sheet is then preferably creped after application of the binder to one or both sides of the sheet. Such sheets are described in U.S. patent application Ser. Nos. 10/192,781, filed Jul. 10, 2002; 10/447,321, filed May 28, 2003; 10/326,915, filed Dec. 20, 2002; 10/382,222, filed Mar. 5, 2003; 10/319,415, filed Dec. 13, 2002; 10/654,219, filed on Sep. 2, 2003; 10/654,289, filed on Sep. 2, 2003; and 10/749,475, filed Dec. 31, 2003, which are all incorporated herein by reference. Such sheets are found to be very drapable having very low stiffness and high bulk softness. Such sheets are widely recognized for their clothlike texture. While the absorbent capacity of such sheets tends to be lower than the absorbent capacity of sheets made with through air dried tissue such products have a much more clothlike feel and may be preferred for higher end applications such as disposable placemats.

The hydroentangled web or the highly debonded sheet printed with a latex or acrylate binder can be laminated to the sheet by a latex or acrylate adhesive using Flexographic printing or through cast or extrusion of the polymeric film directly on the webs described above.

In addition to comprising two layers or two plies, the fluid absorbent sheets in various embodiments may contain further plies and/or layers. For example, in one embodiment, a fluid absorbent layer may be positioned between the fluid impervious layer and a top, apertured layer. The apertured layer may be present in order to reduce the tendency of liquids to migrate back to the top surface of the product after being absorbed. The apertured layer may comprise an apertured film. The apertures, for example, may have an opening area greater than about 0.5 mm². The ratio of apertured area to non-apertured area can range from about 0.1 to about 0.9, such as from about 0.2 to about 0.8.

In still another embodiment of the present invention, the fluid absorbent sheet may comprise a fluid impervious layer positioned in between a first fluid absorbent layer and a second fluid absorbent layer which allows either side of the sheet to be used for absorbing fluids. The first fluid absorbent layer may have the same or different properties than the second fluid absorbent layer depending upon the particular application.

When the fluid absorbent sheets are contained in a spirally wound product, the product may include periodically spaced perforation lines for separating the individual sheets. Alternatively, the spirally wound product may be housed in a container that includes a cutting edge for allowing the user to select the sheet length as desired.

The fluid absorbent sheets may contain various additives for improving various properties of the sheets. For example, the fluid absorbent sheets may contain antimicrobial agents, odor absorbing agents, and the like. In one embodiment, the fluid absorbent sheet may also include a fluid barrier that surrounds at least a portion of the perimeter of each sheet. The fluid barrier may serve to contain all fluids within the sheet. The fluid barrier may comprise, for instance, superabsorbent particles. In an alternative embodiment, the fluid barrier may comprise a liquid impervious adhesive material that has been placed around the perimeter of the product.

Various other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of one embodiment of a spirally wound absorbent product made in accordance with the present invention;

FIG. 2 is a perspective view of one embodiment of a fluid absorbent sheet made in accordance with the present invention;

FIG. 3 is a perspective view of another alternative embodiment of a fluid absorbent sheet made in accordance with the present invention;

FIG. 4 is a perspective view of another embodiment of a fluid absorbent sheet made in accordance with the present invention;

FIG. 5 is a perspective view with cutaway portions of still another embodiment of a fluid absorbent sheet made in accordance with the present invention;

FIG. 6 is yet another embodiment of a fluid absorbent sheet made in accordance with the present invention;

FIG. 7 is a perspective view illustrating a spirally wound product made in accordance with the present invention positioned in a container that includes a cutting edge;

FIG. 8 is a perspective view of another embodiment of a fluid absorbent sheet made in accordance with the present invention; and

FIG. 9 is a perspective view of another alternative embodiment of a fluid absorbent sheet made in accordance with the present invention.

Repeat use of reference characters in the present specification and drawings is intended to represent the same or analogous features or elements of the present invention.

### DEFINITIONS

As used herein, the term “hydroentangled web” refers to a high pulp content nonwoven composite fabric. The composite fabric contains more than 50%, such as more than 70%, by weight pulp fibers which are hydraulically entangled into a continuous filament substrate, such as a spunbond substrate. Examples of hydroentangled webs are disclosed in U.S. Pat. No. 5,284,703, which is incorporated herein by reference.

As used herein, the term “spunbond fibers” refers to small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

The “Hercules Size Test” is a measure of absorbency. The test measures the time required for the reflectance of a material to decrease to a predetermined value as a dye solution penetrates through the material. Results are reported in seconds, with values less than about 5 indicating a reasonably absorbent product. Materials with low absorbency characteristics typically have values greater than 1 minute. Liquid impermeable products, such as films, have very high values.

As used herein, the term “coform web” refers to a material produced by combining separate polymer and additive streams into a single deposition stream in forming a nonwoven web. Such a process is taught,.for example, by U.S. Pat. No. 4,100,324 to Anderson, et al. which is hereby incorporated by reference.

As used herein, the term “geometric mean tensile modulus” is calculated as follows. Specimens are tested in a standard tensile tester. A 3 inches jaw width, a jaw span of 4 inches, and a crosshead speed of 10 inches per minute is used after maintaining the sample under TAPPI conditions for 4 hours before testing. The load cell is chosen such that the majority of the peak load results fall between 10% and 90% of the capacity of the load cell.

Tensile energy absorbed (TEA) at break is the integral of the force produced by a specimen with its elongation up to the defined break point (65% drop in peak load), divided by the face area of the specimen. The face area is the slack-corrected gage length times the specimen width.

The MD and CD slope is also referred to as the tensile modulus. It is the slope of the stress strain curve between 46 g and 103 g of force. The geometric mean modulus is the square root of the product of the MD and CD slopes.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to fluid absorbent mats that may be used in various and sundry applications. In general, the mats include a liquid absorbent layer and a liquid impervious layer. The two layers may be combined in a single ply or may comprise separate plies that are laminated together either alone or in combination with further plies.

The fluid absorbent mats of the present invention are particularly well suited for use in food preparation applications. For example, the mats are configured to absorb and capture excess liquid or juices that may be generated during the defrosting, preparing, cutting, chopping or slicing of foods. The liquid absorbent mat, for instance, may be used as a surface to season, remove fat, or prepare hamburger patties from meat products. The liquid absorbent mats are also well suited in various applications for cutting and chopping fruits and vegetables. Of particular advantage, the mats are configured to quickly absorb liquids while preventing the liquids from escaping from the product or striking through the product.

In addition to food preparation operations, the liquid absorbent mats of the present invention may also be used in various other applications. For instance, the liquid absorbent mats may be used for chemical spill absorption, blood or urine pickup or may be used in various other wiping applications. The mats are also capable of receiving embossments and/or graphics making them visually appealing for use as placemats.

The liquid absorbent mats may be packaged individually such as in a stacked arrangement. Alternatively, the mats may be interconnected and spirally wound together. When present in a rolled product, for example, the mats may have a relatively small caliper and a high bending modulus. For instance, in one embodiment, the overall caliper of the product can range from about 20 microns to about 1,000 microns, such as from about 40 microns to about 800 microns. In one particular embodiment, for example, the caliper of the mats may range from about 60 microns to about 600 microns. Within the above caliper range, the liquid absorbent mats may have a basis weight of from about 3 gsm to about 400 gsm, such as from about 5 gsm to about 100 gsm, more specifically from about 10 gsm to about 80 gsm.

When the liquid absorbent mats are not intended to be in a spirally wound relationship, the mats may have a much higher caliper and basis weight than the ranges provided above. For instance, the caliper of the mats may range from about 1 mil to about 100 mils, such as from about 5 mils to about 50 mils. The thickness and basis weight will vary greatly depending upon the resulting application. For example, placemats and food preparation mats, that only offer the absorbent top layer and leak proof bottom layer, may have a caliper of from about 3 mils to about 30 mils, while food preparation mats particularly designed for absorbency and cutting, chopping or slicing foods may have a caliper of from about 10 mils to about 100 mils.

As described above, the liquid absorbent mats at least include a liquid absorbent layer and a liquid impervious layer. For example, the liquid absorbent layer may have a Hercules Size Test (HST) value of less than about 5 seconds, while the liquid impervious layer may have a HST value of greater than about 1 minute, such as greater than about 2 minutes. For example, in one embodiment, the liquid impervious layer may have a HST value of greater than about 4 minutes.

Many different materials may be used in order to construct the liquid absorbent layer and the liquid impervious layer. For some applications, for instance, materials may be chosen for the liquid absorbent layer such that the layer has a liquid absorbent capacity of at least one gram water per gram mass, such as greater than about 2 grams water per gram mass or even greater than about 4 grams water per gram mass. The liquid absorbent layer can also be configured to have high Z-directional tensile to resist sloughing and linting of fibers onto any items brought into contact with the mats such as a food product. In one embodiment, for instance, the Z-directional tensile of the layer may be greater than about 4 psi, such as greater than about 8 psi, and even greater than about 12 psi.

Examples of materials that may be used to form the liquid absorbent layer include wetlaid tissue webs, airlaid webs, coform webs, hydroentangled webs, and the like. When formed from a wetlaid tissue web, the paper web may be formed from various processes known in the art. For example, the tissue web may be formed from processes that include creping, wet creping, double creping, embossing, wet-pressing, air-pressing, through-air drying, creped through-air drying, uncreped through-air drying, as well as other various conventional steps. The paper web may also be subjected to a double print crepe process or subjected to a single print crepe process in which a bonding material is applied to at least one side of the web according to a pattern, adhered to a creping surface, and then creped from the surface.

The liquid impervious layer, on the other hand, may be formed from a film or a nonwoven. The nonwoven, for example, may be constructed so as to have a HST value that falls within the above described ranges. The nonwoven web may be, for instance, a meltspun web or a hydroentangled web.

When the liquid impervious layer comprises a film, in general, any suitable film may be used. The film may be made from, for example, a homopolymer, a copolymer, a blend of polymers or a multi-layered film. In one embodiment, for instance, the film may contain a polyolefin such as polyethylene or polypropylene. In an alternative embodiment, the polymer film may contain a NYLON (polyamide), a fluoropolymer, PEEK, polyphenylene sulfide, and mixtures thereof. The above polymers may be well suited to applications where the absorbent mat is used also as a cutting surface. In another embodiment, the film may comprise or have a layer of high coefficient of friction polymer (such as a block copolymer, i.e. SEB-S block copolymer) on one side of the film to impart a non-slip attribute to the mat. A non-slip feature is especially important for a food prep mat designed for cutting, chopping or slicing food to help keep the mat from moving about the counter while cutting food.

The film may have a thickness that varies greatly depending upon the particular application. For example, in one embodiment, the film may have a thickness of less than 1 mil to greater than 30 mils, such as from about 0.5 mil to about 5 mils. The basis weight of the polymeric film can likewise vary over a wide range. For example, the basis weight may range from about 5 gsm to about 100 gsm such as from about 5 gsm to about 50 gsm. For spirally wound products the basis weight of the film is preferably less than about 30 gsm and the thickness of the film is preferably less than about 4 mils (0.004″). Lower calipers tending to reduce the stiffness of the product and facilitate utilization as a rolled product giving the consumer the impression of a standard paper towel product.

In one embodiment, there may be advantages to using a film that has a relatively high opacity. Clear film laminates may give the impression to the user of being wet during use even though fluids are prevented from passing through the film. A film having a relatively high opacity, on the other hand, provides a visual cue to the user that fluid strikethrough has not occurred. Opacity represents a substrate's light blocking ability. It is primarily used as a property of paper and predicts the relative visibility on one side of the paper of the images that exist on the other side. The opacity of polymer films is typically measured using the same procedure, TAPPI procedure T 425 and ASTM procedure D 589. There two different ways to report opacity the more common being the “89% reflectance backing,” also called “contrast ratio.” This value is equal to 100 times the ratio of the diffuse reflectance of a film sample backed by a black body (<0.5% reflectance) to the diffuse reflectance of the same sample backed by a white body (89% reflectance). The units are percent, and a perfectly opaque material will have an opacity value of 100%. The opacity of the film, for instance, may be greater than about 40%, such as greater than about 50%. In one particular embodiment, for example, the opacity of the film may be greater than about 60%.

In other embodiments it may be preferred or sufficient to use translucent films. Translucent films are measured by a haze value and not opacity. Haze is the scattering of light by a film that results in a cloudy appearance or poorer clarity of objects when viewed through the film. More technically, haze is the percentage of light transmitted through a film that is deflected more than 2.5° (degrees) from the direction of the incoming beam. A unidirectional perpendicular light beam is directed onto the film specimen, and a photo detector measures the total light transmitted by the specimen after it enters an integrating sphere. Testing for haze in films should be done by a method such as ASTM D-1003 or equivalent. A spectrophotometer may also be used provided that it meets the requirement of ASTM D-1003. Translucent films suitable for the present invention may have haze values greater than 10% such as greater than 20%. In one specific embodiment the film may be diffusing, having a haze value greater than 30%.

Transparent films may also be used to satisfaction in the present invention. Such films will have haze values less than 10% such as less than 5% and specifically less than 3% when measured by ASTM D-1003 or equivalent.

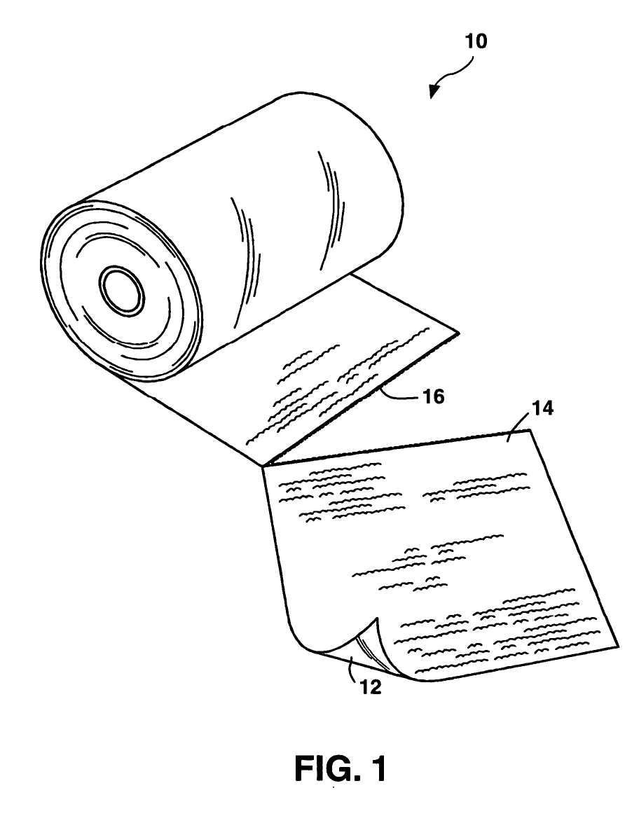

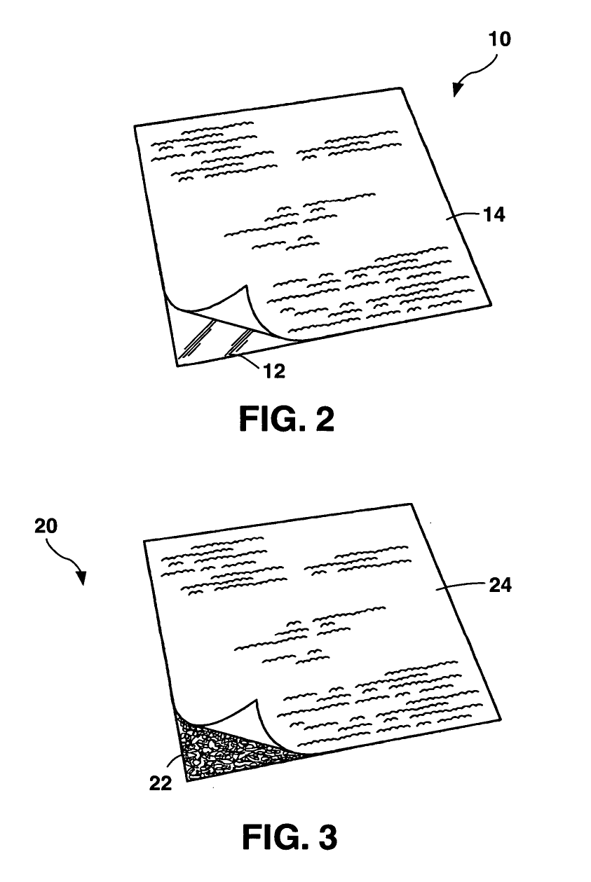

Referring to the figures, various embodiments of liquid absorbent mats or sheets made in accordance with the present invention are shown. For example, referring to FIGS. 1 and 2, a liquid absorbent mat generally 10 is shown that comprises a laminate of a film 12 to a liquid absorbent web 14. As shown in FIG. 1, in one embodiment, the liquid absorbent mat 10 may comprise a spirally wound product. The spirally wound product or roll of material may periodically include perforation lines 16 for separating individual liquid absorbent mats from the remainder of the roll. In other embodiments, however, it should be appreciated that the mats may be packaged in a stacked arrangement. Whether or not the mats are spirally wound may depend upon the caliper of the product, the bending modulus of the product and the basis weight.

When delivered as a spirally wound product the dimensions of the roll are preferably controlled to give the perception of equivalence to current paper towel products. By controlling the dimensions of the roll of the spirally wound product the consumer is better able to locate the product within their current environment where commercially available paper towels are located. In fact, the consumer may find that the products of the present invention meet all the needs of currently available spirally wound paper towel products and may be inclined to replace the currently available products with those of the present invention in their entirety. Spirally wound products of the present invention preferably have an outer roll length (sheet width) dimension of from about 6″ to about 14″, such as from about 8″ to about 12″ and a roll diameter of from about 3″ to about 9″, such as from about 5″ to about 8″. The total length of all sheets on the roll is determined by the particular diameter of the roll and the caliper of the sheet. In one embodiment the total sheet length on the roll can range from about 20 feet to about 120 feet, such as from about 30 feet to about 100 feet and more specifically from about 40 feet to about 100 feet.

When spirally wound, it may be preferable to have the absorbent side facing the outside of the roll. In this manner the consumer will have visual contact with the absorbent side and will be more likely to perceive the roll as being paper towel like and, hence, more apt to use said product for applications served by conventional spirally wound paper towel products. It one embodiment, it is preferred to have the spirally wound product located on a core, however this is not a necessity of the invention. The core may be made from a variety of materials such as cardboard. The cores may have any dimension but in general will have a diameter of from about 1″ to about 2.5″ being similar in shape and dimension to cores used in commercially available spirally wound paper towel products.

The liquid absorbent layer 14 and the film layer 12 of the mats 10 as shown in FIGS. 1 and 2 can be constructed from any suitable combination of materials as described above. In one particular embodiment, for instance, the liquid absorbent layer 14 may comprise a tissue web made primarily from cellulosic fibers. For example, the tissue web may comprise an uncreped through-air dried web. Uncreped through air dried tissues such as that described in U.S. Pat. No. 5,656,132 are found to have better bulk, greater wet resiliency, greater absorbent rate and higher specific absorbent capacity than traditional wet pressed tissue products. Thus, less cellulose fiber and fewer plies are needed to maintain a given specific absorbent capacity.

It would be expected that the specific fiber absorbent capacity would increase with lamination of the fiber web to an impervious layer. The specific fiber absorbent capacity refers to the amount of fluid in grams that the products of the present invention can hold per gram of absorbent fiber in the product. It is most applicable to products having an absorbent layer comprising primarily cellulosic fibers laminated to a polymeric film fluid impervious layer. Water or fluid becomes trapped in the void areas between the fiber web and the fluid impervious layer. In the absence of the fluid impervious layer, this fluid merely transfers to the surface in contact with the web or simply drains off the web.

When used in a spirally wound product the absorbent layer preferably exhibits good wet resiliency. Wet resiliency refers to the ability of the sheet to not collapse when wetted. The sheet therefore retains its 3-dimensional shape in the presence of water. While not wishing to be bound by theory, it is believed that three factors interact synergistically to yield unusually high wet resiliency performance: (1) a high bulk (low density) three-dimensional structure obtained without significant compression during drying and preferably obtained without creping, (2) high yield pulp fibers, preferably comprising at least about 20 percent of the fiber furnish used to make the sheet; and (3) the use of one or more wet strength resins or agents such that the wet to dry geometric mean tensile strength ratio is about 0.1 or greater. More information about wet resiliency can be found in U.S. Pat. No. 6,808,790 B2 entitled “Wet-resilient webs and disposable articles made therewith” by Chen et.al and issued Oct. 26, 2004, which is incorporated herein by reference.

While not wishing to be bound by theory it is believed that wet resiliency of the sheet allows the sheet to retain its 3-d form rather than collapsing into the voids between the film and the fiber surfaces. As a result, water or other fluids become trapped in the void volume between the fluid impervious layer and the surface of the sheet facing the impervious layer but not substantively affixed to that layer. If a conventional wet pressed tissue sheet is used, these void areas rapidly collapse and can not serve to provide additional absorbent capacity. As such, when the absorbent layer of the products of the present invention comprises a material having high wet resiliency the fiber absorbent capacity of the product, expressed in grams fluid per gram of fiber, will be greater than using a conventional wet pressed tissue sheet. Highly texturized surfaces having a significant 3-d structure can be utilized to further increase the fiber absorbent capacity. Thus less fiber is required to achieve the same absorbent capacity and the overall product cost can be substantially reduced. Uncreped through-air dried webs are particularly well suited to absorbing liquids in that the web not only quickly absorbs liquids but can absorb large quantities of liquids. The uncreped through-air dried web may have a basis weight of from about 10 gsm to about 120 gsm, such as from about 30 gsm to about 90 gsm.

Wet resiliency may be incorporated into the web by bonding the web to the film, by mechanical entanglement, or through the use of wet strength resins. For example, permanent wet strength agents comprising cationic oligomeric or polymeric resins may be used in the present invention. Polyamide-polyamine-epichlorohydrin type resins such as KYMENE 557H sold by Hercules, Inc. located at Wilmington, Delaware are the most widely used permanent wet-strength agents and are suitable for use in the present invention. Such materials have been described in the following U.S. Pat. Nos. 3,700,623, issued on Oct. 24, 1972 to Keim; 3,772,076, issued on Nov. 13, 1973 to Keim; 3,855,158, issued on Dec. 17, 1974 to Petrovich et al.; 3,899,388, issued on Aug. 12, 1975 to Petrovich et al.; 4,129,528, issued on Dec. 12, 1978 to Petrovich et al.; 4,147,586, issued on Apr. 3, 1979 to Petrovich et al.; and, 4,222,921, issued on Sep. 16, 1980 to van Eenam. Other cationic resins include polyethylenimine resins and aminoplast resins obtained by reaction of formaldehyde with melamine or urea.

The tissue web 14 may be laminated to the film 12 using any suitable method or technique. The laminate may be bonded across the entire plane of the product or may be bonded at only selected regions. The particular adhesive or method of bonding the individual layers together is generally not critical to the invention. Specific bonding techniques may include, for instance, flexographically printing an adhesive or a water based adhesive emulsion in between the layers, spraying an adhesive between the layers (hot meltor liquid at room temperature adhesives), crimping the layers together, or through thermal bonding such as heat embossing where the film is softened or melted in selected regions and pressed lightly into the absorbent layer and cooled. As the film solidifies it becomes bonded to the absorbent layer. Finally, cast or extrusion laminating of 4 mil thick or greater polyethylene, polypropylene, NYLON or other polymeric film directly onto the absorbent web, such as a Hydroentangled web, is a good way to achieve lamination especially when manufacturing a food prep mat to achieve absorbent and cut resistant features. The cut resistance of the food preparation mat can be improved by adding white or colored pigment to the film. Not only is the cut resistance improved by adding white pigment to the film it is further improved by adding color pigment. The white and colored film improves opacity improving the consumer perception that the mat is durable and cut resistant. The colored film helps the consumer to differentiate which side to cut food on to absorb juices with the absorbent top layer and keep the mat in place during cutting with the leak proof non-slip bottom mat.

While products comprising absorbent layers having high wet resiliency and high amounts of topography may be desirable in many applications, there are other times where it may be advantageous to have a product comprising a smooth sheet with a more clothlike feel. For example, in one embodiment the sheet comprises a highly debonded cellulosic sheet and a latex binder. The sheet may be creped or uncreped. Such sheets generally have a smooth surface texture, high wet strength, high durability, low stiffness and a very clothlike feel and texture. While such sheets tends to have a lower specific absorbent capacity than the through air dried tissue sheets previously mentioned, the improved texture and feel may make them more suitable for such applications as disposable placemats.

For example in one embodiment such cellulosic sheets can be prepared by 1) forming a wet laid tissue sheet preferably debonded, 2) applying to one side of the web a latex comprising a binder material having a glass transition temperature of less than about 40° C., 3) drying and creping said sheet such that the latex side is against the dryer, 4) applying to the second side of said sheet a latex binder material having a glass transition temperature of less than about 40° C., 5) drying and creping said sheet such that the second side of said sheet is in contact with the dryer and 6) optionally curing said sheet to affect crosslinking of the binder. Examples of such tissue products and methods to make such products can be found in U.S. Pat. No. 3,879,257 by Gentile, et. al entitled “Absorbent unitary laminate-like fibrous webs and method for producing them” assigned to Scott Paper Company and issued Apr. 22, 1975. Such materials are at times referred to as Double Re-Creped or DRC sheets. A variety of binders are known in the art and may be used. Particular suitable are styrene butadiene, polyvinylchloride and ethylene vinyl acetate binders such as EN-1165 and A-124 available from Air Products Corporation and Elite® PE Binder available from National Starch, Inc.

Various other processes are suitable for making such clothlike cellulosic structures. Acceptable products and process are described in commonly assigned U.S. patent application Ser. Nos. 10/192,781, filed Jul. 10, 2002; 10/447,321, filed May 28, 2003; 10/326,915, filed Dec. 20, 2002; 10/382,222, filed Mar. 5, 2003; 10/319,415, filed Dec. 13, 2002; and 10/749,475, filed Dec. 31, 2003. These so called print creped and dual re-creped webs clothlike feel can be characterized by the sheet's high tensile energy absorption (TEA) and low geometric mean tensile modulus (stiffness). The geometric mean tensile strength of the print creped web without the fluid impervious layer, defined as the square root of the product of the machine direction tensile strength and the cross direction tensile strength is preferably about 900 g/3″ or greater such as from about 900 g/3″ to about 5000 g/3″ in one embodiment to from about 1000 g/3″ to about 3000 g/3″ in another embodiment. The geometric mean modulus of the print creped web without the fluid impervious layer, defined as the square root of the product of the machine direction tensile modulus and the cross direction tensile modulus is preferably less than about 11 kg such as less than about 9 kg in one embodiment to about less than 7 kg in another embodiment. On the other hand the geometric mean tensile energy absorption defined as the square root of the product of the machine direction and cross direction tensile energy absorption is preferably greater than 15 g-cm/cm² such as greater than about 17 g-cm/cm², such as from about 17 g-cm/cm² to about 40 g-cm/cm².

In an alternative embodiment, instead of using a tissue web, the liquid absorbent layer 14 may comprise a hydroentangled web. Hydroentangled webs generally comprise a meltspun web that has been hydraulically entangled with pulp fibers, such as softwood or hardwood fibers. For example, water jets may be used to hydroentangle pulp fibers with the meltspun web on at least one side of the web. Hydroentangled webs are commercially available from the Kimberly-Clark Corporation under the tradename HYDROKNIT® Nonwoven Fabric.

In one embodiment, the hydroentangled web 14 may contain from about 60% to about 95% by weight pulp fibers, such as from about 70% to about 90% by weight. The overall basis weight of the web may be from about 30 to about 175 gsm, such as from about 50 to about 125 gsm. In one particular embodiment, for instance, the web may have a basis weight of from about 70 gsm to about 90 gsm.

In another embodiment, the hydroentangled web has 1-30 mm long polymeric fibers added to the pulp portion of the sheet to improve cut resistance.

When laminated to the film 12, the pulp side of the hydroentangled web may face away from the film or be placed adjacent to the film. In general, better liquid absorbency characteristics are observed if the pulp side of the hydroentangled web forms the top layer of the laminate.

Of particular advantage, hydroentangled webs are capable of thermally bonding with various films. The webs also provide some degree of cut resistance, especially when combined with cut resistant polymeric films 4 mils thick or greater. This will allow a cut resistance of between 12 and 27 kgf/cm. Also of advantage, hydroentangled webs may be formed having a relatively large pore size which allows the webs to quickly absorb large amounts of liquids before liquid can pool on the surface or leak over the edge of the mat 10. For instance, the hydroentangled web may have an equivalent hydraulic diameter of greater than about 900 microns, such as greater than about 1,000 microns. The hydroentangled web may also have an equivalent circular diameter of greater than about 1,000 microns, such as greater than about 1100 microns.

In still another embodiment of the present invention, the liquid absorbent layer 14 may comprise an airlaid web. The airlaid web may contain cellulosic fibers, such as fluff pulp, rayon fibers, cotton fibers, and mixtures thereof. In one particular embodiment, for instance, the airlaid web 14 may comprise softwood fluff pulp and from about 5% to about 20% by weight of an adhesive material or binder. The binder may be, for instance, ethylene vinyl acetate. The binder is present to give the web some integrity, especially in the Z-direction.

The basis weight of the airlaid web 14 can vary depending upon the particular application and the amount of liquid that may need to be absorbed during use. The basis weight of the airlaid web 14, for instance, may vary from about 35 gsm to about 85 gsm. For example, in one embodiment, the airlaid web may have a basis weight of from about 45 gsm to about 75 gsm.

Similar to the other absorbent layers described above, the airlaid web 14 may be laminated to any suitable film. In one particular embodiment, for instance, the film may comprise a polyolefin film, such as a polypropylene film. The film, for instance, may have a thickness of from about 0.5 mils to about 5 mils, such as from about 0.5 mils to about 1 mil. The film may be laminated to the airlaid web using any suitable adhesive, such as an ethylene vinyl acetate adhesive. In one particular embodiment, the total caliper of the absorbent mat 10 may range from about 0.5 mm to about 2 mm, such as from about 0.5 mm to about 1 mm.

Referring to FIG. 3, an alternative embodiment of a liquid absorbent mat generally 20 made in accordance with the present invention is shown. In this embodiment, the liquid absorbent mat 20 includes a liquid absorbent layer 24 similar to the liquid absorbent layers described above. As shown, the liquid absorbent layer 24 is laminated to a liquid impervious layer 22. In this embodiment, as opposed to the embodiment shown in FIGS. 1 and 2, the liquid impervious layer 22 comprises a nonwoven. The liquid impervious nonwoven layer 22 may be made from various suitable materials. It should be understood that the nonwoven web 22 does not have to be completely liquid impermeable but simply must be capable of preventing liquids from rapidly striking through the product. For example, as described above, the nonwoven web 22 may have a HST value of greater than about 1 minute, such as greater than about 2 minutes.

In one particular embodiment, for instance, the nonwoven web 22 may have a HST value of greater than about 4 minutes.

In various embodiments, the substantially water impervious nonwoven layer 22 may comprise a meltspun web, such as a spunbond web, meltblown web, or laminate thereof that has the necessary degree of water impermeability. For instance, the meltspun web may be hot calendered in order to improve the liquid impervious characteristics of the web.

In an alternative embodiment, the liquid impervious nonwoven layer 22 may comprise a hydroentangled web. Again, the hydroentangled web may be hot calendered in order to increase the ability of the web to stop fluid flow.

Referring to FIG. 5, still another embodiment of a liquid absorbent mat generally 30 made in accordance with the present invention is shown. Similar to the embodiment shown in FIG. 3, the mat 30 as shown in FIG. 5 includes a nonwoven liquid absorbent layer 34 and a nonwoven liquid impervious layer 32. In this embodiment, however, the liquid absorbent layer 34 is shown to have a highly textured topography in relation to the nonwoven 32.

In this embodiment, for instance, the liquid impervious layer 32 has a smooth topography while the absorbent top layer 34 has a textured surface or other visual cue for the consumer to determine which side of the sheet to use. In one particular embodiment, for instance, the liquid absorbent layer 34 may comprise a highly textured uncreped through-air dried tissue web, while the liquid impervious layer 32 may comprise a meltspun web.

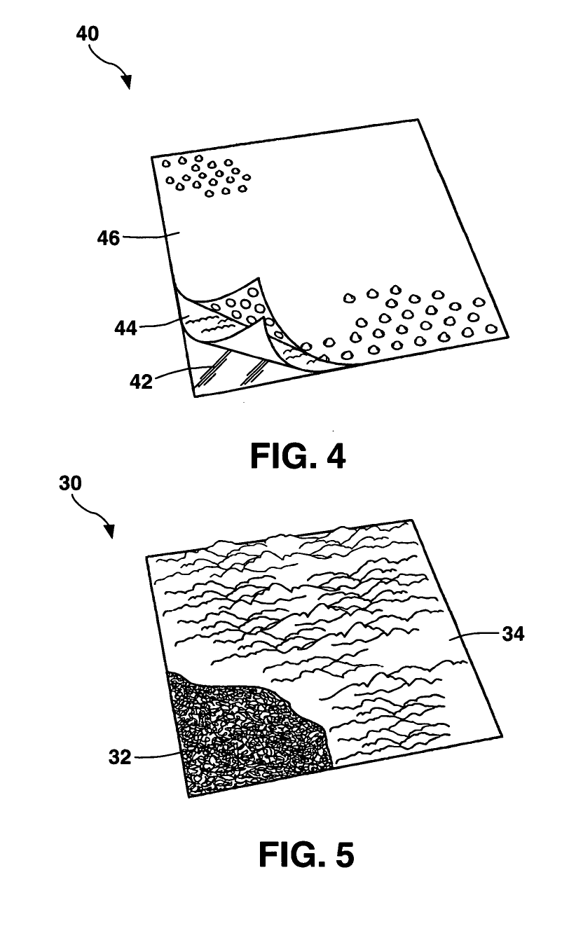

Still another embodiment of a liquid absorbent mat generally 40 made in accordance with the present invention is shown in FIG. 4. As illustrated, the liquid absorbent mat 40, in this embodiment, includes a liquid impervious layer 42 which is represented as a film but may also be a nonwoven. A liquid absorbent layer 44 is positioned on top of the liquid impervious layer 42. The liquid absorbent mat 40 further includes a top layer 46 comprising a liquid impervious sheet that has been apertured to allow liquid to flow into the absorbent layer 44. The apertured layer 46 allows liquids to be absorbed by the product while reducing the tendency of the liquids to migrate back to the top surface of the product.

The liquid impervious apertured top layer 46 is preferably of a very low thickness so as to not impart any undesirable stiffness into the product. The top layer 46 will have a thickness typically less than 5 mils, such as less than about 4 mils in one embodiment to less than about 2 mils in another specific embodiment.

The apertures contained in the top sheet 46 may be of any size but in general may have an opening area greater than about 0.5 mm. For instance, the opening area may range from about 0.5 mm to about 2 mm. The ratio of apertured area to non-apertured area may also vary but may range from about 0.1 to about 0.9, such as from about 0.2 to about 0.8. In one particular embodiment, for instance, the ratio of apertured area to non-apertured area may be from about 0.25 to about 0.6.

The number of apertures present on the top sheet 46 can be at a frequency of from about 3 apertures per linear inch to about 800 apertures per linear inch, such as from about 5 apertures per linear inch to about 600 apertures per linear inch, and still more specifically from about 10 apertures per linear inch to about 400 apertures per linear inch when measured in any direction of the sheet.

The apertures formed into the top sheet 46 may be made by a variety of methods. Perforated embossing of the layer can be used such that during embossing, penetration of the layers is achieved thereby creating a physical puncture through the top sheet. The perforated embossing can be done either on the individual layers or plies or on the entire product. Other methods to form the apertures include pin aperturing, die punching, die stamping, water knives that cut out the desired holes in the web, vacuum assisted aperturing whereby a high vacuum is applied to one side of the web as the web is supported by a porous surface, laser cutters, needle punching, and the like.

In one particular embodiment, fibers of the liquid absorbent layer 44 may fill or partially fill the apertures of the top sheet 46 further enhancing the ability of liquids to be transported into the absorbent layer 44. Needling techniques similar to the carding process can be used to manipulate fibers into the apertures. Alternatively, needles having hooks or materials having small hooks, such as the hook material of hook and loop fasteners, can be used to pull fibers into the apertures upon withdrawal while also creating the apertures as the hooks or needles are pushed into the tissue product.

Referring to FIG. 6, still another embodiment of a liquid absorbent mat generally 50 made in accordance with the present invention is shown. In this embodiment, the liquid absorbent mat 50 includes a liquid impervious layer 52 positioned in between a first liquid absorbent layer 54 and a second liquid absorbent layer 56. Liquid absorbent mat 50 may be particularly advantageous since either side of the mat may be used with equal efficaciousness. The liquid absorbent layer 54 may be the same or different from the liquid absorbent layer 56. In general, any suitable liquid absorbent layer as described above or any suitable liquid impervious layer as described above may be used to construct the mat 50.

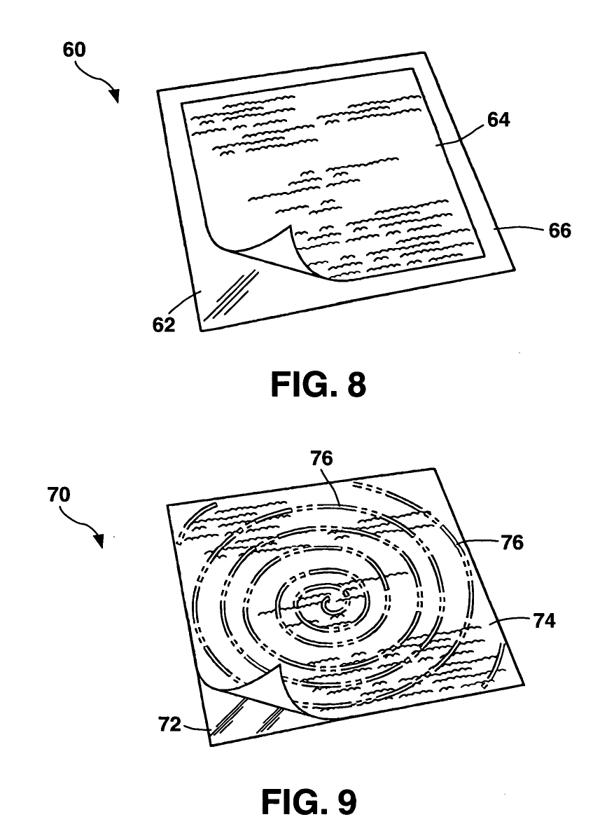

Referring to FIG. 8, still another embodiment of an absorbent mat generally 60 made in accordance with the present invention is illustrated. In this embodiment, the mat 60 includes a liquid impervious layer 62 and a liquid absorbent layer 64. As shown, the liquid impervious layer 62 is larger in size than the liquid absorbent layer 64. In this manner, a liquid impervious rim 66 is formed around the mat 60. The liquid impervious rim 66 may be present in order to prevent liquids from leaving the edges of the mat 60. In one embodiment, the rim 66 may be made from multiple layers of material and thus may be elevated to further prevent liquids from running off the product.

In one particular embodiment, the liquid absorbent mat 60 as shown in FIG. 8 may further be combined with an apertured top sheet as shown in FIG. 4. The apertured top sheet may provide for improved cut resistance while still allowing liquids to be absorbed by the product.

It should be understood that the liquid impermeable rim 66 as shown in FIG. 8 may be combined with any of the other embodiments discussed or described above.

In addition to a rim 66 as shown in FIG. 8, in other embodiments, various other liquid barriers may be incorporated into the product. For example, in an alternative embodiment, superabsorbent particles may be incorporated into the product around at least a portion of the perimeter of the product. The superabsorbent particles are capable of absorbing greater amounts of liquid and thus preventing runoff. The superabsorbent particles may be spread around the entire perimeter of the product, over a portion of the perimeter of the product, or may be spread over the entire surface area of the product. When placed around the perimeter of the product, the superabsorbent particles not only absorb liquids, but may also swell to provide a ridge or an increased height to further prevent runoff.

In still another embodiment of the present invention, a bead of adhesive material may be placed around the product to prevent liquid runoff. The adhesive material, for instance, may be a hotmelt adhesive. The hotmelt adhesive may be applied around the perimeter of the product or applied in other areas.

For example, referring to FIG. 9, still another embodiment of a liquid absorbent mat generally 70 made in accordance with the present invention is shown. In this embodiment, the mat 70, which includes a liquid impervious layer 72 and a liquid absorbent layer 74, further includes concentric rings, a spiral, or labyrinth-like fluid barriers 76 incorporated into the product. The fluid barrier 76 may be made from an adhesive material, such as a hotmelt adhesive. Depending upon how the fluid barriers 76 are arranged, the barriers may be used either to contain liquids within the product or to channel the liquids to a particular location.

Any of the embodiments of the fluid absorbent mats shown in the drawings may further include various additives to improve the properties of the product. For example, in one embodiment, an antimicrobial agent may be incorporated into the product. For instance, silver ions or zeolites may be embedded into the absorbent layer and/or the liquid impervious layer. Other various antimicrobial agents may also be used. Such antimicrobial agents include MICROBAN particles, chitosan or other polymers or non-dissolving agents known to have antimicrobial or bacteriostatic activity.

In still another embodiment, an odor absorbing agent may be incorporated into the liquid absorbent mat 60. The odor absorbent may be, for instance, carbon particles.

In addition to various additives, the liquid absorbent mat can also be subjected to various post treatment processes in order to improve the properties of the mat or to improve the aesthetic qualities of the mat. For instance, the mats may be printed with various designs and may be embossed to either improve fluid intake or to enhance the appearance of the product.

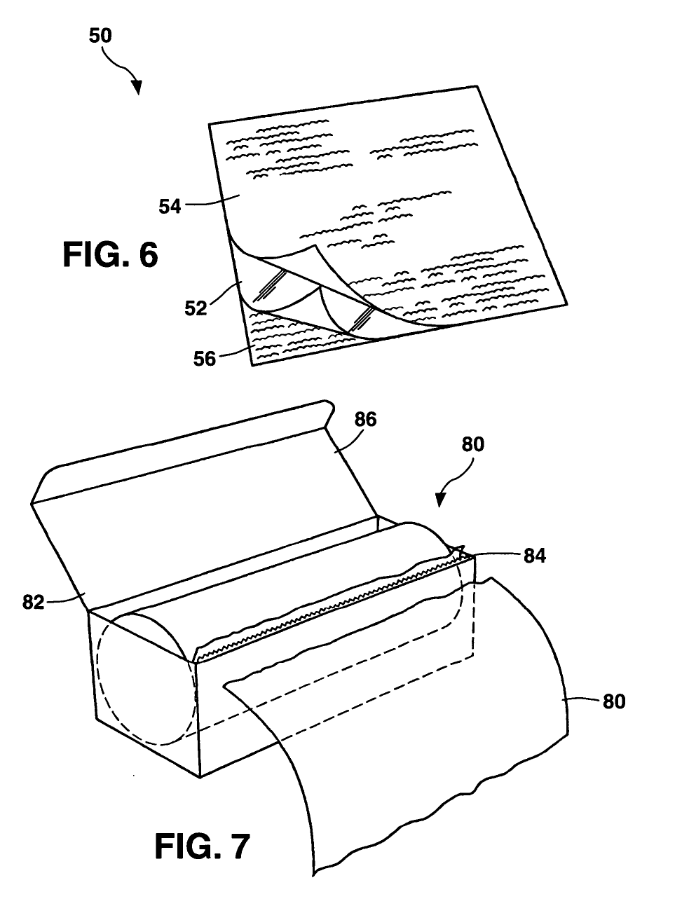

As described above, in one embodiment, the liquid absorbent mat may be contained in a spirally wound form. In one embodiment as shown in FIG. 7, the spirally wound fluid absorbent mat 80 may be contained in a container 82. The container 82 may have a lid 86 and a cutting edge 84. In this manner, the desired length of the liquid absorbent mat may be pulled from the spirally wound product and then cut using the cutting edge 84.

The present invention may be better understood with reference to the following examples.

### EXAMPLES

Various liquid absorbent placemats were constructed according to the present invention and tested for various physical properties including pore size and fiber diameter, absorbent rate, and cut resistance. Specifically, in Examples 1 through 3, the mats were produced from a hydroentangled web laminated to a polyolefin film.

### Example 1

In the following example, the hydroentangled webs contained in the mats were tested for pore size and fiber diameter, specifically testing for equivalent hydraulic diameter (EHD) and the equivalent circular diameter (ECD). A larger pore size can quickly absorb large amounts of liquid before the liquid can pool on the surface or leak over the edge of the mat. In this example the following samples were produced and tested:

Sample 1 was constructed out of a 5 mil HDS polyethylene film extrusion laminated to a 82 gsm hydroentangled web with the spunbond side out. The spunbond portion of the hydroentangled web had a basis weight of 0.35 osy.

Sample 2 was constructed out of a 5 mil HDS polyethylene film extrusion laminated to a 82 gsm hydroentangled web with the pulp side out. The spunbond portion of the hydroentangled web had a basis weight of 0.35 osy. The following tests were performed on the samples:
I. Sample Prep—Sample sidedness and directionality were noted and six small squares (˜1×1 cm²) were randomly cut from each sample. The squares were mounted on an SEM stub and gold coated using a Denton Desk II sputter coater. Thickness was approximately 400-500 angstroms.
II. Image Collection—A Jeol 840 secondary electron microscope (SEM) was used to acquire backscatter-electron/high-contrast (BSE/HICON) images. The following imaging conditions and setting were used:
a. Working Distance (WD)=24
b. Accelerating=10.0 kV
c. Probe Current=1×10⁻⁸ amps
d. Aperture setting=3
e. Use the 1% rule (i.e., smallest fibers should be at least 1 mm thick on the SEM screen) to determine the magnification.
f. Once the mag is determined, it must be kept constant for all images of a single sample
g. BE Imaging settings (may vary with different SEMS and condition of instrument)
   i. Suppress—fully counter-clockwise
   ii. Gain (course)=3
   iii. Gain (fine) approx. 11:30
   iv. Brightness approx. 9:00
   v. Topo approx. 12:00
Acquiring BE Images Using Polaroid Film
1. Use type-51 (T-51) Polaroid film to acquire the BE image
2. Make sure the camera is set for T-51 film
   a. Aperture=f/22
   b. B=4.0
   c. C=4.3
3. Repeat the entire image acquisition process (step 12-15 under Procedural Steps) so that two Polaroid BE images are acquired for each piece of sample (i.e. total of 12 images for the entire sample).
III. Analysis of Images (Q500 IA System or Matlab macro.) Data were acquired from the BSE/HICON photos by using the Quantimet 600 Image Analysis System and custom-written routine ‘MBPAS1.’ The Quantimet 600 is manufactured by Leica, Inc. (Cambridge, UK). Other imaging conditions and resources used were as follows:
   Quantimet 600 Image Software—QWIN version 1.06
   Camera—SONY Model DXC-930P
   Camera mount—Polaroid MP4 Land Camera (79.3 cm)
   Lens—35-mm adjustable Nikon (f-stop=4)
   Lighting—Four flood lamps (150 Watt—GE Reflector)
   Auto-stage—12″×12″ Designed Components Inc. (Franklin, Miss.)
   Programming—Quantimet User Interactive Programming
   System (QUIPS) The custom routine is shown below.

Six regions were sampled for each code, and two images were acquired per region (n=6). Two fields-of-view (FOV) were analyzed for each of the two images acquired per region.

This resulted in a total of 12 BSE/HICON photos for each code and 24 FOV total.

Image Analysis Routine
NAME: MBPAS1
PURPOSE: SCANS N# OF PHOTOMONTAGES TO GIVE POROSITY CHARACTERISTICS
CONDITIONS: 35 MM ADJ. NIKON LENS; F/4; 4 FLOODS; SONY 3CCD CAMERA; POLE=79.3
AUTHOR: DAVE BIGGS
DATE: AUG. 10, 2004
COMMONCALVALUE=93.1
TOTANISOT=0
TOTFIELDS=0
PERCAREA=0
TOTPERCAREA=0
Enter Results Header
Calibrate (CALVALUE CALUNITS$ per pixel)
PauseText (“Enter SEM magnification used.”)
Input (MAG)
CALVALUE=COMMONCALVALUE/MAG
Image Setup [PAUSE] (Camera 5, White 82.32, Black 100.00, Lamp 24.69)
Measure frame (x 32, y 32, Width 676, Height 515)
For (REPLICATE=1 to 2, step 1)
Clear Field Histogram #1
Clear Feature Histogram #1
Clear Feature Histogram #2
Clear Feature Histogram #3
Clear Feature Histogram #4
Stage (Define Origin)
Stage (Scan Pattern, 1×4 fields, size 109000.429688×69999.921875)
For (FIELD=1 to 4, step 1)
Image Setup (Camera 5, White 83.91, Black 100.00, Lamp 24.69)
Acquire (into Image0)
Grey Amend (Close from Image0 to Image1, operator Disc, cycles 3)
Detect (blacker than 103, from Image1 into Binary0 delineated)
Binary Amend (Open from Binary0 to Binary1, cycles 1, operator Disc, edge erode on)
MFLDIMAGE=0
Measure field (plane MFLDIMAGE, into FLDRESULTS(4))
Selected parameters: Area, Count, Anisotropy, Area %
ANISOT=FLDRESULTS(3)
TOTANISOT=TOTANISOT+ANISOT
TOTFIELDS=TOTFIELDS+1
PERCAREA=FLDRESULTS(4)
TOTPERCAREA=TOTPERCAREA+PERCAREA
   Field Histogram #1 (Y Param Number, X Param Area %, from 0. to 75., linear, 15 bins)
   Measure feature (plane Binary1, 8 ferets, minimum area: 10, grey image: Image0)
   Selected parameters: Area, X FCP, Y FCP, Length, Breadth, Perimeter,
   UserDef1, UserDef2, UserDef3, UserDef4, UserDef5
   Feature Expression (UserDef1 (all features), title ECD1=(4*PAREA(FTR)/3.1416)**0.5)
   Feature Expression (UserDef2 (all features), title EHD1=4*PAREA(FTR)/PPERIMETER(FTR))
   Feature Expression (UserDef3 (all features), title FTRCALCB=(8/(3*3.1416)*(PAREA(FTR)**2)/PLENGTH(FTR))/100000)
   Feature Expression (UserDef4 (all features), title ECD1 CONV=((4*PAREA(FTR)/3.1416)**0.5)/CALVALUE)
   Feature Expression (UserDef5 (all features), title EHD1 CONV=(4*PAREA(FTR)/PPERIMETER(FTR))/CALVALUE)
   Display Feature Results (x 64, y 716, w 832, h 281)
Feature Accept:
UserDef5 from 4. to 1000.
Feature Histogram #1 (Y Param Number, X Param UserDef2, from 10. to 10000., logarithmic, 15 bins)
Feature Histogram #2 (Y Param Area, X Param UserDef2, from 10. to 10000., logarithmic, 15 bins)
Clear Accepts
Feature Accept:
UserDef4 from 4. to 1000.
Feature Histogram #3 (Y Param Number, X Param UserDef1, from 10. to 10000., logarithmic, 15 bins)
Feature Histogram #4 (Y Param UserDef3, X Param UserDef2, from 10. to 10000., logarithmic, 15 bins)
Clear Accepts
Stage (Step, Wait until stopped+10×55 msecs)
Next (FIELD)
PRINT:
Set Print Position (8 mm, 24 mm)
Print Results Header
Print (“FIELD COUNT VS % AREA HISTOGRAM”, tab follows)
Print Line
Print Field Histogram Results (#1, horizontal, differential, bins+graph (Y axis linear), statistics)
Print (“AVERAGE % AREA=”, no tab follows)
Print (TOTPERCAREA/TOTFIELDS, 2 digits after ‘.’, tab follows)
Print Line
Print (“AVERAGE PORE ANISOTROPY (TAN THETA)=”, no tab follows)
Print (TOTANISOT/TOTFIELDS, 3 digits after ‘.’, no tab follows)
Set Image Position (left 87 mm, top 127 mm, right 191 mm, bottom 197 mm, Aspect=None,
Caption:Bottom Centre, “A Representative Image @ 50× Magnification”)
Grey Util (Print Image0)
Print Page
Set Print Position (8 mm, 8 mm)
Print Results Header
Print (“PORE COUNT VS. EHD (4*A/P)”, no tab follows)
Print Line
Print Feature Histogram Results (#1, horizontal, differential, bins+graph (Y axis linear), statistics)
Print (“CUMMULATIVE PORE % AREA VS EHD (4*A/P)”, no tab follows)
Print Line
Print Feature Histogram Results (#2, horizontal, differential, bins+graph (Y axis linear), statistics)
Print Page
Set Print Position (8 mm, 8 mm)
Print Results Header
Print (“PORE COUNT VS. ECD [SQR(4*A/PI)}”, no tab follows)
Print Line
Print Feature Histogram Results (#3, horizontal, differential, bins+graph (Y axis linear), statistics)
Print (“EHD (4*AREA/PERIMETER) vs. ELLIPSOIDAL VOLUME [(8/3PI)*AREA**2/LENGTH}”, no tab follows)
Print Line
Print Feature Histogram Results (#4, horizontal, differential, bins+graph (Y axis linear), statistics)
Print Page
If (REPLICATE=3)
Go to STOP
Endif
Stage (Move to 109999.804688, 0.000000, Wait until stopped+10×55 msecs)
Next (REPLICATE)
STOP:
CALVALUE=CALVALUE*MAG
   END

The following results were obtained:

| Sample | EHD (um) | Area-wt. EHD | ECD (um) |
|---|---|---|---|
| 1 | 1043.7 | 1327.0 | 1111.5 |
| 2 | 1062.4 | 1406.6 | 1158.0 |

### Example 2

In the following example various mats were tested for cut resistance in both the Machine Direction (MD) and the Cross Direction (CD). In this example the following samples were produced and tested:

Sample 3 was constructed out of a 5.5 mil polypropylene film cast laminated to a 125 gsm hydroentangled web with the pulp side out. The spunbond portion of the hydroentangled web had a basis weight of 0.75 osy.

Sample 4 was constructed out of a 5.5 mil polypropylene film cast laminated to a 125 gsm hydroentangled web with the spunbond side out. The spunbond portion of the hydroentangled web had a basis weight of 0.75 osy.

Sample 5 was constructed out of a 5 mil polypropylene film cast laminated to a 82 gsm hydroentangled web with the pulp side out. The spunbond portion of the hydroentangled web had a basis weight of 0.35 osy.

Sample 6 was constructed out of a 6 mil polypropylene film cast laminated to a 82 gsm hydroentangled web with the pulp side out. The spunbond portion of the hydroentangled web had a basis weight of 0.35 osy.

The following cut resistance tests were performed on the samples. The test is described in U.S. Pat. No. 6,383,615.

The test apparatus applies a known force in the z (vertical) direction on a knife blade to measure the cut resistance of a sample. A knife blade was placed in the knife holder. The knife blades used for all testing were Poultry Blades Code # 88-0337 by Personna. The test sample was mounted to a sample platform. The knife blade was then brought into contact with the sample. A known load was applied to the knife blade in the vertical direction. The sample platform was then moved at a rate of 8 inches per second for 4 inches under the weight of the knife blade creating a slice. Consecutive slices of increasing load were made until the knife blade cut through the sample. The knife force required to penetrate completely through the sample was recorded. Slice resistance was calculated as the slice force/sample thickness. The test was then replicated on 4-5 separate samples and average values were reported. The following results were obtained:

| Sample | MD (kgf/cm) | CD (kgf/cm) |
|---|---|---|
| 3 | 12.75 | 14.71 |
| 4 | 12.59 | 16.03 |
| 5 | 10.19 | 11.37 |
| 6 | 13.77 | 14.43 |

### Example 3

In the following example the hydroentangled webs contained in the mats were tested for their absorbent rate. In this example the following samples were produced and tested:

Sample 7 was constructed out of a 5.5 mil polypropylene film cast laminated to a 82 gsm hydroentangled web with the pulp side out. The spunbond portion of the hydroentangled web had a basis weight of 0.35 osy.

Sample 8 was constructed out of a 5.5 mil polypropylene film cast laminated to a 82 gsm hydroentangled web with the spunbond side out. The spunbond portion of the hydroentangled web had a basis weight of 0.35 osy.

Sample 9 was constructed out of a 5.5 mil polypropylene film cast laminated to a 82 gsm hydroentangled web with the pulp side out. The spunbond portion of the hydroentangled web had a basis weight of 0.75 osy.

Sample 10 was constructed out of a 6 mil polypropylene film cast laminated to a 82 gsm hydroentangled web with the spunbond side out. The spunbond portion of the hydroentangled web had a basis weight of 0.75 osy.

The following test was conducted on the samples:
1. Cut the specimen to 6 inches by 6 inches.
2. Use a ruler to mark the center of the specimen.
3. Use paper towels to ensure that the FIFE board and cylinder are clean and completely dry.
4. Verify the amount of dyed solution being dispensed from the Nalgene® variable-volume dispenser (Kimberly Clark item number 1464745; part number 3702-0025).
   a. Set the variable-volume dispenser to 5 milliliters.
   b. Fill the variable-volume dispenser cup by squeezing the bottle and forcing the dye solution up into the variable-volume dispenser cup.
   c. Pour the solution from the variable-volume dispenser cup into a graduated cylinder. Ensure that the volume is 5±0.5 milliliters.
   d. If necessary, adjust the height of the dispenser cup until the volume falls within the acceptable range.
5. Place and center the specimen, absorbent side up, on the bottom section of the FIFE board. Smooth the specimen by pulling gently on the edges of the product to avoid creases or wrinkles.
6. Place the top section of the FIFE board over the specimen. Ensure that the mark at the center of the specimen is aligned with the center of the cylinder opening.
7. Press lightly on the top section of the FIFE board to impress the cylinder ridge into the specimen.
8. Quickly pour 5±0.5 milliliters of dyed solution from the variable-volume dispenser cup into the cylinder and simultaneously start the timer. Try to pour directly onto the specimen rather than the walls of the cylinder.

9. Observe the testing fluid intake through the cylindrical opening in the top section of the FIFE board. Stop the timer immediately when the testing fluid is not visible on the specimen surface within the cylindrical opening area. Record this time to the 0.1 second as the Absorbent Rate. The following results were obtained:

| Sample | Avg. rate (g/s − sgcm) 70° F. |
|---|---|
| 7 | 0.0007 |
| 8 | 0.0004 |
| 9 | 0.0007 |
| 10 | 0.0003 |

### Example 4

Measurement of Absorbent Capacity:

Procedure—Single Absorbent Side Products

The following procedure is used when a sample has an absorbent side and a non-absorbent side. The Dual Absorbent Side procedure should be used for products where both outer sides are absorbent layers with the barrier being in the center of the two layers or plies. All samples should be conditioned at standard TAPPI conditions for a minimum of 4 hours prior to testing.

A sample specimen 4±0.04 inches by 4±0.04 inches is cut using a swing beam cutting machine (SB-20, USM Corporation or equivalent) or a manual paper cutter (McMaster-Carr Supply Co. part # 3823A44 or equivalent) and weighed to the nearest 0.01 gram on a balance. The “dry weight” is recorded. A weighing dish is tared on the balance. The sample specimen is attached on one end to a pinch type clamp such as shown below with the specimen attached to the clip or clips on the clamp. A container is filled with a sufficient volume of water to insure that the test specimen can be fully submerged. The water temperature should be maintained at 23+/−3° C. The specimen and clamp are then placed into the water absorbent side up using a tongs. A timer is immediately started. The specimen is allowed to soak in the water for 30+/−5 seconds. The specimen is removed from the water by grasping the clamp with the tongs. The sample is then suspended in air by hanging from the clamp for 30+/−5 seconds. The clamp is shaken one time by bringing the sample plane to horizontal and rotating the sample plane to vertical in less than 1 second. The specimen is then released from the clamp, absorbent side up, onto a blotter paper so as to remove any water from the non-absorbent side. Care should be taken to avoid contacting the absorbent side of the sample with the blotter paper. The non-absorbent side should be completely contacting the blotter paper and non of the absorbent side contacting the blotter paper. The specimen is allowed to sit on the blotting paper for 1-5 seconds. The specimen is then removed from the blotter and placed on a tared weighing dish and the weight of the wet sample “Wet Weight” recorded to the nearest 0.01 gram. The absorbent capacity in g/cm2, specific absorbent capacity (g water/g sample) or fiber absorbent capacity (g water/g cellulose fiber) can then be determined using the following equations:

$$Absorbent Capacity ( g \text{/} {cm}^{2} ) = \frac{Wet Weight ( g ) - Dry Weight ( g )}{Sample area}$$

$$Where \text{:} sample area = 103.23 {cm}^{2}$$

$$Specific Absorbent Capacity ( g \text{/} {cm}^{2} ) = \begin{matrix}Wet Weight ( g ) - Dry Weight ( g ) \\ Dry Weight ( g )\end{matrix}$$

$$Fiber Specific Absorbent Capacity ( g \text{/} g ) = \frac{Wet Weight ( g ) - Dry Weight ( g )}{Fiber weight}$$

Absorbent Capacity:
Procedure—Dual Absorbent Side

The following procedure is used to measure the absorbent capacity of products having two absorbent sides as well as the absorbent capacity of the fluid absorbent layer without the fluid impermeable layer.

A sample specimen 4±0.04 inches by 4±0.04 inches is cut using a swing beam cutting machine (SB-20, USM Corporation or equivalent) or a manual paper cutter (McMaster-Carr Supply Co. part # 3823A44 or equivalent) and weighed to the nearest 0.01 gram on a balance. The “dry weight” is recorded. A weighing dish is tared on the balance. The sample specimen is attached on one end to a pinch type clamp such as shown below with the specimen attached to the clip or clips on the clamp. A container is filled with a sufficient volume of water to insure that the test specimen can be fully submerged. The water temperature should be maintained at 23+/−3° C. The specimen and clamp are then placed into the water absorbent side up using a tongs. A timer is immediately started. The specimen is allowed to soak in the water for 30+/−5 seconds. The specimen is removed from the water by grasping the clamp with the tongs. The sample is then suspended in air by hanging from the clamp for 30+/−5 seconds. The clamp is shaken one time by bringing the sample plane to horizontal and rotating the sample plane to vertical in less than 1 second. The specimen is then released from the clap and placed on a tared weighing dish and the weight of the wet sample “Wet Weight” recorded to the nearest 0.01 gram. The absorbent capacity, specific absorbent capacity and fiber absorbent capacity are calculated using the same equations as for the single absorbent sided sheets.

A single-ply uncreped through air dried tissue sheet having a basis weight of 39 g/m² and a specific absorbent capacity of 7.0 g/g was laminated to a 12 g/m² polypropylene film using an adhesive. The adhesive was applied in approximately ¾″ wide lines along the MD direction of the sheet. The adhesive was applied along both outer edges and then along MD lines across the CD of the sheet spaced about 2″ apart. The finished basis weight of the sheet was 51 g/m². The absorbent capacity of the sheet was found to be 0.036 g/cm², the specific absorbent capacity of the finished sheet was found to be 7.16 g/g and the specific fiber absorbent capacity found to be 9.41 g/g fiber.

### Example 5

A commercially available poly backed laminated tissue product having a basis weight of 100 g/m² comprising a 12 g/m² polypropylene film laminated to 3 plies of conventional wet pressed tissue having a basis weight of 88 g/m2 was found to have an absorbent capacity of 0.069 g/cm², a specific absorbent capacity of 7.14 g/g and a specific fiber absorbent capacity found to be 8.12 g/g fiber. The specific absorbent capacity of the tissue basesheet was found to be 6.71 g/g.

The benefits of using an uncreped through air dried sheet can be seen by the 16% greater specific fiber absorbent capacity compared to the sample in Example 2 despite using a single ply instead of 3-plies of tissue. While both products show an increase in fiber absorbent capacity when applying the fluid impermeable layer the fiber absorbent capacity increases by 34% in the case of the more resilient structure in Example 2 versus 21% for the less resilient wet pressed tissue sheet of Example 1.

### Example 6

A single-ply uncreped through air dried tissue sheet having a basis weight of 39 g/m2 and a specific absorbent capacity of 7.0 g/g was laminated to both sides of a 12 g/m2 polypropylene film using an adhesive. The adhesive was applied in approximately ¾″ wide lines along the machine direction of the sheet. The adhesive was applied along both outer edges and then along MD lines across the cross direction of the sheet spaced about 2″ apart. The finished basis weight of the sheet was 90 g/m2. The absorbent capacity of the sheet was found to be 0.073 g/cm2, the specific absorbent capacity of the finished sheet was found to be 8.15 g/g and the specific fiber absorbent capacity found to be 9.38 g/g fiber.

### Example 7

A single ply of airlaid sheet having a basis weight of 55 g/m² was laminated to a 0.75 mil thick polypropylene film with a vinyl acetate adhesive using a Flexographic process with a patterned adhesive application with a 17% coverage area.

### Example 8

A single ply of sheet highly debonded creped, double creped or double re-creped latex or acrylate binder printed on highly debonded web having a basis weight of 55 g/m² was laminated to a 0.75 mil thick polypropylene film with a vinyl acetate adhesive using a Flexographic process with a patterned adhesive application with a 17% coverage area.

### Example 9

A single ply of Hydroentangled web having a basis weight of 82 gsm was cast or extrusion laminate to a 5.5 mil thick polypropylene film with a high coefficient layer on the bottom of the film to impart a non-slip feature to the mat. The sample was tested for its coefficient of friction according to ASTM Test No. D1894-99. This mat has a machine direction (MD) coefficient of friction (COF) of 1.5 and a cross direction (CD) COF of 1.5. and a cut resistance of 22.1 kgf/cm.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A rolled absorbent product having a sheet width of from about 6″ to about 14″ and a roll diameter of from about 3″ to about 8″ wherein said rolled absorbent product comprises a plurality of spirally wound interconnected fluid absorbent sheets, the sheets including a first fluid absorbent layer and a second fluid impervious layer, the first layer of the sheets having a HST value of less than about 5 seconds, the second layer of the sheets having a HST value of greater than about 1 minute, the sheets having a caliper of less than about 800 microns and a basis weight of less than about 150 gsm, the first fluid absorbent layer having a liquid absorption capacity of at least 4 g/g.

2. A rolled absorbent product as defined in claim 1, wherein the fluid absorbent layer is located at the outer surface of the spirally wound absorbent product.

3. A rolled absorbent product as defined in claim 1, wherein the fluid absorbent sheets have a caliper of from about 40 microns to about 800 microns and have a basis weight of from about 5 gsm to about 90 gsm.

4. A rolled absorbent product as defined in claim 3, wherein the fluid absorbent sheets have a caliper of from about 60 microns to about 600 microns.

5. A rolled absorbent product as defined in claim 1, wherein the second fluid impervious layer has a HST value of greater than about 2 minutes.

6. A rolled absorbent product as defined in claim 1, wherein the fluid impervious layer comprises a polymeric film having a thickness of from about 0.05 to about 4 mils.

7. A rolled absorbent product as defined in claim 6, wherein the polymeric film has a basis weight of from about 5 g/m2 to about 30 g/m2.

8. A rolled absorbent product as defined in claim 1, wherein each fluid absorbent sheet comprises a laminate, the fluid absorbent layer comprising a first ply of the laminate and the fluid impervious layer comprising a second ply of the laminate.

9. A rolled absorbent product as defined in claim 8, wherein each fluid absorbent sheet further comprises a third layer, said third layer comprising an apertured layer made from a fluid impervious material, the fluid absorbent layer being positioned in between the fluid impervious layer and the apertured layer, said apertured layer having a thickness of about 4 mils or less.

10. A rolled absorbent product as defined in claim 9, wherein the apertured layer contains apertures having an area of at least 0.5 mm² and wherein the apertured layer has a ratio of apertured area to non-apertured area of from about 0.1 to about 0.9.

11. A rolled absorbent product as defined in claim 10, wherein the fluid absorbent layer comprises a tissue web containing cellulosic fibers, and wherein the apertures of the apertured layer contains cellulosic fibers from the absorbent layer pulled through the apertures.

12. A rolled absorbent product as defined in claim 1, wherein the fluid absorbent layer comprises a tissue web of one or more plies and the fluid impervious layer comprises a film.

13. A rolled absorbent product as defined in claim 12, wherein the tissue web comprises a creped through-air dried web or an uncreped through air dried web.

14. A rolled absorbent product as defined in claim 13, wherein the tissue web comprises a single ply.

15. A rolled absorbent product as defined in claim 12, wherein the fluid absorbent layer has a specific fiber water absorbent capacity of about 9 grams per gram fiber or greater.

16. A rolled absorbent product as defined in claim 8, wherein the fluid impervious layer comprises a nonwoven web.

17. A rolled absorbent product as defined in claim 1, wherein the fluid absorbent sheets are separated by a perforation line.

18. A rolled absorbent product as defined in claim 1, further comprising a container that contains the spirally wound fluid absorbent sheets, the container including a cutting edge for severing the rolled absorbent product into the fluid absorbent sheets.

19. A rolled absorbent product as defined in claim 1, wherein the fluid absorbent sheets contain an antimicrobial agent.

20. A rolled absorbent product as defined in claim 1, wherein the fluid absorbent sheets contain an odor absorbing agent.

21. A rolled absorbent product as defined in claim 1, wherein the fluid absorbent sheets include a third layer, said third layer comprising a fluid absorbent layer, the fluid impervious layer being located in between the first fluid absorbent layer and the third fluid absorbent layer.

22. A rolled absorbent product as defined in claim 1, wherein the fluid absorbent sheets only contain two layers.

23. A rolled absorbent product as defined in claim 8, wherein the fluid absorbent layer comprises a uncreped through-air dried tissue web, a print creped tissue web, an airlaid web, a hydroentangled web, or a coform web.

24. A rolled absorbent product as defined in claim 8, wherein the fluid impervious layer comprises a film containing polyethylene, polypropylene, or mixtures thereof.

25. A rolled absorbent product as defined in claim 8, wherein the fluid impervious layer comprises a hydroentangled web or a meltspun web.

26. A rolled absorbent product as defined in claim 1, wherein the fluid absorbent sheets include a perimeter and wherein the sheets further comprise a fluid barrier positioned around at least a portion of the perimeter of each sheet.

27. A rolled absorbent product as defined in claim 26, wherein the fluid barrier comprises superabsorbent particles.

28. A rolled absorbent product as defined in claim 26, wherein the fluid barrier comprises a liquid impermeable outer rim.

29. A rolled absorbent product as defined in claim 26, wherein the fluid barrier comprises a barrier formed from an adhesive material.

30. A rolled absorbent product as defined in claim 5, wherein the fluid impervious layer comprises a film having a haze value greater than 10%.

31. A rolled absorbent product as defined in claim 8, wherein the fluid impervious layer comprises a film having a haze value of about 30% or greater.

32. A rolled absorbent product as defined in claim 8, wherein the fluid impervious layer comprises a film having an opacity of about 50% or greater.

33. A disposable laminate having a fluid absorbing side and a fluid impervious side comprising:
a fluid absorbent layer containing cellulosic fibers, the fluid absorbing layer comprising an airlaid web, a print creped tissue web, or a hydroentangled web;
a fluid impervious layer comprising a film made from a polymeric material, the film having a thickness of from about 0.75 mils to about 50 mils, the polymeric material having a melting point of greater than about 165° C.

34. A disposable laminate as defined in claim 33, wherein the fluid absorbent layer comprises a hydroentangled web.

35. A disposable laminate as defined in claim 33, wherein the fluid absorbent layer comprises an airlaid web.

36. A disposable laminate as defined in claim 34, wherein the hydroentangled web has a basis weight of from about 50 gsm to about 125 gsm.

37. A disposable laminate as defined in claim 36, wherein the hydroentangled web has an equivalent circular diameter of at least 1,000 microns and has an equivalent hydraulic diameter of at least 900 microns.

38. A disposable laminate as defined-in claim 33, wherein the laminate only contains two layers.

39. A disposable laminate as defined in claim 35, wherein the airlaid web comprises fluff pulp and a binder, the airlaid web having a basis weight of from about 40 gsm to about 80 gsm.

40. A disposable laminate as defined in claim 39, wherein the airlaid web is attached to the film by an adhesive material.

41. A disposable laminate as defined in claim 33, wherein the film has a haze value of at least 10%.

42. A disposable laminate as defined in claim 33, wherein the film has a haze value of at least 30%.

43. A disposable laminate as defined in claim 33, wherein the film has an opacity of about 50% or greater.

44. A disposable laminate as defined in claim 33, wherein the fluid impervious layer comprises a film containing polyethylene, polypropylene, or mixtures thereof.

45. A disposable laminate as defined in claim 33, wherein the fluid impervious layer comprises a film containing a polyamide, a fluorocarbon, or a polyphenylene sulfide.

46. A disposable laminate as defined in claim 33, wherein the fluid absorbent layer comprises a double recreped tissue web.

47. A disposable laminate as defined in claim 46, wherein the fluid absorbent layer has a geometric mean tensile modulus of about 12 kg or less.

48. A disposable laminate as defined in claim 46, wherein the fluid absorbent layer has a geometric mean tensile modulus of about 8 kg or less.

49. A disposable laminate as defined in claim 36, wherein the film is cast or extrusion laminated to the hydroentangled web, the laminate having a cut resistance of between 12 and 27 kgf/cm.

50. A disposable laminate as defined in claim 39, wherein the film is cast or extrusion laminated to the airlaid web.

51. A disposable laminate as defined in claim 36, wherein the fluid impervious layer is cast or extrusion laminated to the hydroentangled web, the film having a coefficient of friction value of between 1 and 3, the laminate having a cut resistance of between 12 and 27 kgf/cm.

52. A disposable laminate as defined in claim 51, wherein the film contains a white or colored pigment.

53. A disposable laminate as defined in claim 51, wherein the laminate has an absorbent capacity of about 1 g/g to about 10 g/g.

54. A disposable laminate as defined in claim 33, wherein the fluid absorbent layer comprises a print creped tissue web, the film having a coefficient of friction value between about 1 and about 3 and wherein the absorbent layer has an absorbent capacity of from about 1 g/g to about 10 g/g.

55. A disposable laminate as defined in claim 33, wherein the fluid absorbent layer comprises a print creped tissue web having a basis weight of from about 40 gsm to about 80 gsm.

56. A disposable laminate as defined in claim 51, wherein the laminate further contains an antimicrobial agent.

57. A disposable laminate as defined in claim 51, wherein the laminate further contains an odor control agent.

58. A disposable laminate as defined in claim 33, further comprising a pattern of an adhesive material applied to the fluid absorbent layer, the pattern of the fluid adhesive material improving the cut resistance of the laminate.

59. A disposable laminate comprising a fluid absorbent layer and a fluid impervious layer, the disposable laminate defining a perimeter and wherein the laminate further comprises a fluid barrier positioned around at least a portion of the perimeter of the laminate.

60. A disposable laminate as defined in claim 59, wherein the fluid barrier comprises superabsorbent particles.

61. A disposable laminate as defined in claim 59, wherein the fluid barrier comprises a liquid impermeable outer rim.

62. A disposable laminate as defined in claim 59, wherein the fluid barrier comprises a barrier formed from an adhesive material.
